(19) United States
(12) Patent Application Publication
(10) Pub. No.: US 2019/0270932 A1
(43) Pub. Date: Sep. 5, 2019

(54) LIGHT LUMINESCENT PARTICLE

(71) Applicant: Merck Patent GmbH, Darmstadt (DE)

(72) Inventor: Arjan MEIJER, Reinheim (DE)

(73) Assignee: Merck Patent GmbH, Darmstadt (DE)

(21) Appl. No.: 16/348,910

(22) PCT Filed: Nov. 8, 2017
(86) PCT No.: PCT/EP2017/078566

§ 371 Date: May 10, 2019

(30) Foreign Application Priority Data
Nov. 11, 2016 (EP) 16198487.7

(51) Int. Cl. C09K 11/02

(52) U.S. Cl. CPC C09K 11/025

(57) ABSTRACT

The present invention relates to a light luminescent particle comprising a nanosized light emitting material, and use of said light luminescent particle. The present invention further relates to a composition comprising a light luminescent particle, an optical medium, and an optical device. The present invention also relates to method for preparing of said luminescent particle.

### FIELD OF THE INVENTION

The present invention relates to a light luminescent particle comprising a nanosized light emitting material, and use of said light luminescent particle. The present invention further relates to a composition comprising a light luminescent particle, an optical medium, and an optical device. The present invention also relates to method for preparing of said luminescent particle.

### BACKGROUND ART

Light luminescent particles comprising a nanosized light emitting material are known in the prior art.

For example, as described in WO 2014/140936 A2, WO2011/036447 A1, WO2016/059020 A2.

### PATENT LITERATURE

1. WO 2014/140936 A2
2. WO2011/036447 A1
3. WO2016/059020 A2

### Non Patent Literature

None

### SUMMARY OF THE INVENTION

However, the inventors newly have found that there is still one or more of considerable problems for which improvement is desired as listed below.
1. Novel light luminescent particle comprising a nanosized light emitting material, which shows better initial absolute quantum yield after fabrication of said light luminescent particle, is desired.
2. Novel light luminescent particle comprising a nanosized light emitting material, having improved thermal resistivity, is required.
3. Novel light luminescent particle comprising a nanosized light emitting material, which provide better moisture resistivity, is also desired.
4. Novel light luminescent particle comprising a nanosized light emitting material, having longer life time, is still a need for improvement.
5. Simple fabrication process for making a light luminescent particle comprising a nanosized light emitting material, is requested.

The inventors aimed to solve one or more of the problems indicated above 1 to 5.

Surprisingly, the inventors have found a novel light luminescent particle (100), said light luminescent particle (100) comprising an inner core (110) and a polymer layer (140) placed over the inner core (110), wherein said inner core (110) comprises a nanosized light emitting material (120), and an organic material (130) selected from one or more members of the group consisting of alkyl chains having 5-42 carbon atoms, alkenyl chains having 5-42 carbon atoms, and alcohols having 5 to 42 carbon atoms, which solves one or more of the above mentioned problems 1 to 5. Preferably, said mixture solves all the problems 1 to 5 at the same time.

In another aspect, the invention relates to the use of the light luminescent particle (100) in an optical medium or a biomonitoring device.

In another aspect, the invention further relates to a composition comprising the light luminescent particle (100), and one selected from a matrix material or a solvent.

In another aspect, the invention relates to an optical medium comprising the light luminescent particle (100).

In another aspect, the invention further relates to an optical device comprising the optical medium.

In another aspect, the invention furthermore relates to method for preparing of the light luminescent particle (100), wherein the method comprises following step (a), (b) and (c),

(a) preparing a composition comprising a nanosized light emitting material (120), and an organic material (130), a precursor for the polymer layer (140), a polymerization initiator, a polar solvent, and a polymer solve in said polar solvent,
(b) stirring the composition obtained in step (a) at a temperature in the range from the melting point of the organic material (130) to 99° C.,
(c) polymerizing the precursor by heat treatment, by irradiating a ray of light, or a combination of any of these.

Further advantages of the present invention will become evident from the following detailed description.

### DESCRIPTION OF DRAWINGS

FIG. 1: shows a cross sectional view of a schematic of one embodiment of a light luminescent particle (100).

FIG. 2: shows the measurement results of working example 7.

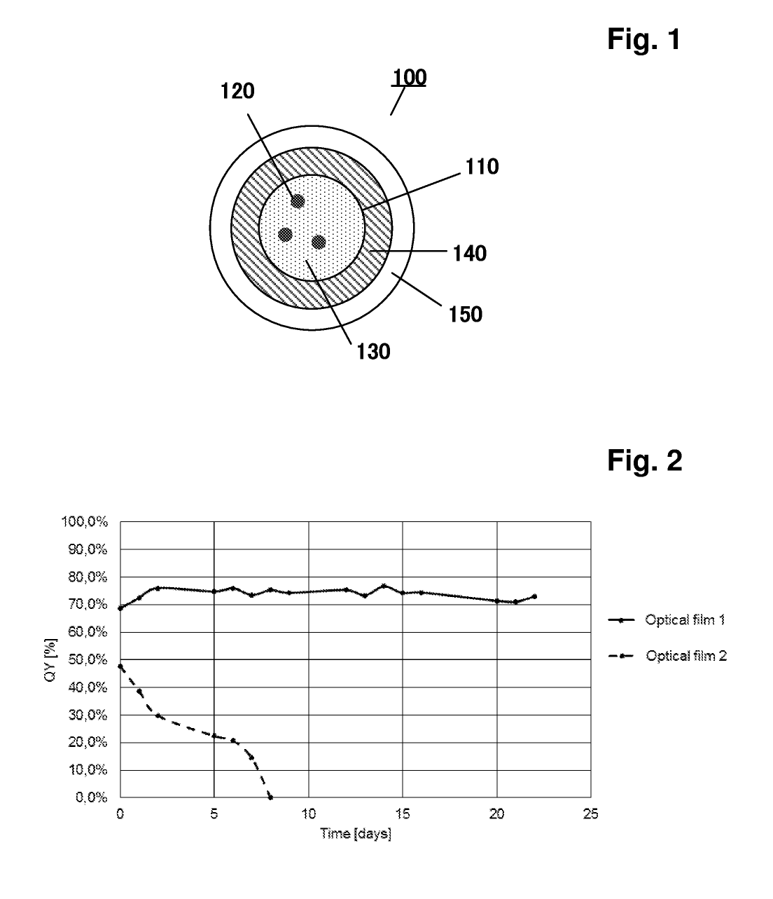

### LIST OF REFERENCE SIGNS IN FIG. 1

100. a light luminescent particle
110. an inner core
120. a nanosized light emitting material
130. an organic material
140. a polymer layer
150. a protection layer (optional)

### DETAILED DESCRIPTION OF THE INVENTION

According to the present invention, said light luminescent particle (100) comprising an inner core (110) and a polymer layer (140) placed over the inner core (110), wherein said inner core (110) comprises a nanosized light emitting material (120), and an organic material (130) selected from one or more members of the group consisting of alkyl chains having 5-42 carbon atoms, alkenyl chains having 5-42 carbon atoms, and alcohols having 5 to 42 carbon atoms, solves one or more of the above mentioned problems 1 to 5.

Preferably the light luminescent particle (100) according to the present invention solves all the problems 1 to 5 at the same time.

Inner Core (110)

According to the present invention, the inner core (110) comprises a nanosized light emitting material (120), and an organic material (130) selected from one or more members of the group consisting of alkyl chains having 5-42 carbon atoms, alkenyl chains having 5-42 carbon atoms, and alcohols having 5 to 42 carbon atoms.

In a preferred embodiment of the present invention, the inner core (110) comprises a nanosized light emitting material (120), and an organic material (130) selected from one or more members of the group consisting of alkyl chains having 5-42 carbon atoms, and alkenyl chains having 5-42 carbon atoms.

In some embodiments, the core (110) can further comprises one or more of organic solvents to adjust refractive index value of the inner core (110) to the polymer layer (140) and to increase outcoupling efficiency of the light luminescent particle (100).

In a preferred embodiment of the present invention, the inner core (110) comprises a plurality of nanosized light emitting materials (120), and an organic material (130) selected from one or more members of the group consisting of alkyl chains having 5-42 carbon atoms, and alkenyl chains having 5-42 carbon atoms.

More preferably, the inner core (110) essentially consists of a plurality of nanosized light emitting materials (120), and an organic material (130) selected from one or more members of the group consisting of alkyl chains having 5-42 carbon atoms, and alkenyl chains having 5-42 carbon atoms.

Even more preferably, the inner core (110) consists of a plurality of nanosized light emitting materials (120), and an organic material (130) selected from one or more members of the group consisting of alkyl chains having 5-42 carbon atoms, and alkenyl chains having 5-42 carbon atoms.

Nanosized Light Emitting Material (120)

According to the present invention, as a nanosized light emitting material (120), a wide variety of publically known nanosized light emitting material can be used as desired.

A type of shape of the nanosized light emitting material of the present invention is not particularly limited.

Any type of nanosized light emitting material, for examples, spherical shaped, elongated shaped, star shaped, pyramidal shaped, tetrapod shaped, banana shaped, platelet shaped, cone shaped, irregular shaped or polyhedron shaped semiconductor nanocrystals, can be used in this way.

According to the present invention, the term “nano” means the size in between 1 nm and 999 nm.

Thus, according to the present invention, the term “nanosized light emitting material” is taken to mean that a light emitting material which size of the overall diameter is in the range from 1 nm to 999 nm. And in case of the nanosized light emitting material has non spherical shape, such as an elongated shape, the length of the overall structures of the nanosized light emitting material is in the range from 1 nm to 999 nm.

According to the present invention, the term “quantum sized” means the size of the semiconducting material itself without ligands or another surface modification, which can show the quantum confinement effect, like described in, for example, ISBN:978-3-662-44822-9.

Generally quantum sized materials, such as quantum dot materials and quantum rod materials, can emit tunable, sharp and vivid colored light due to “quantum confinement” effect.

Therefore, in a preferred embodiment of the present invention, the nanosized light emitting material is a quantum sized material.

In a preferred embodiment of the invention, the length of the overall structures of the quantum sized material is in the range from 1 nm to 100 nm. More preferably, it is from 2 nm to 50 nm, even more preferably, it is in the range from 3 nm to 20 nm.

In a preferred embodiment of the present invention, the nanosized light emitting material comprises II-VI, III-V, or IV-VI semiconductors and combinations of any of these.

In case of the semiconductor nanocrystal does not have any core/shell structure, the semiconductor nanocrystal can preferably be selected from the group consisting of InP. CdS, CdSe, CdTe, ZnS, ZnSe, ZnSeS, ZnTe, ZnO, InPZnS, InPZn, Cu₂(ZnSn)S₄.

In a preferred embodiment of the present invention, the semiconductor nanocrystals comprise a core/shell structure.

According to the present invention, the term “core/shell structure” means the structure having a core part and at least one shell part covering said core.

In some embodiments of the present invention, said core/shell structure can be core/one shell layer structure, core/double shells structure or core/multishells structure.

According to the present invention, the term “multishells” stands for the stacked shell layers consisting of three or more shell layers.

Each stacked shell layers of double shells and/or multishells can be made from same or different materials.

More preferably, a core of the nanosized light emitting material (120) is selected from the group consisting of Cds, CdSe, CdTe, ZnS, ZnSe, ZnSeS, ZnTe, ZnO, GaAs, GaP, GaAs, GaSb, HgS, HgSe, HgSe, HgTe, InAs, InP, InPZnS, InPZn, InSb, AlAs, AlP, AlSb, Cu₂S, Cu₂Se, CuInS₂, CuInSe₂, Cu₂(ZnSn)S₄, Cu₂(InGa)S₄, TiO₂ alloys and combination of any of these.

In a preferred embodiment of the present invention, shell is selected from the group consisting of II-VI, III-V, or IV-VI semiconductors.

For example, for red emission use CdSe/CdS, CdSeS/CdZnS, CdSeS/CdS/ZnS, ZnSe/CdS, CdSe/ZnS, InP/ZnS, InP/ZnSe, InP/ZnSe/ZnS, InPZn/ZnS, InPZn/ZnSe/ZnS dots or rods, ZnSe/CdS, ZnSe/ZnS or combination of any of these, can be used preferably.

For example, for green emission use CdSe/CdS, CdSeS/CdZnS, CdSeS/CdS/ZnS, ZnSe/CdS, CdSe/ZnS, InP/ZnS, InP/ZnSe, InP/ZnSe/ZnS, InPZn/ZnS, InPZn/ZnSe/ZnS, ZnSe/CdS, ZnSe/ZnS or combination of any of these can be used preferably.

And for blue emission use, such as ZnSe, ZnS, ZnSe/ZnS, or combination of any of these, can be used.

As a quantum dot, publically available quantum dots, for examples, CdSeS/ZnS alloyed quantum dots product number 753793, 753777, 753785, 753807, 753750, 753742, 753769, 753866, InP/ZnS quantum dots product number 776769, 776750, 776793, 776777, 776785, PbS core-type quantum dots product number 747017, 747025, 747076, 747084, or CdSe/ZnS alloyed quantum dots product number 754226, 748021, 694592, 694657, 694649, 694630, 694622 from Sigma-Aldrich, can be used preferably as desired.

In some embodiments, the semiconductor nanocrystal can be selected from an anisotropic shaped structure, for example quantum rod material to realize better out-coupling effect (for example ACS Nano, 2016, 10 (6), pp 5769-5781). Examples of quantum rod material have been described in, for example, the international patent application laid-open No. WO2010/095140A, Luigi Carbone et. al, Nanoletters, 2007, Vol. 7, No. 10, 2942-2950.

In a preferred embodiment of the present invention, the semiconductor nanocrystal additionally comprises a surface ligand.

The surface of the semiconductor nanocrystal can be over coated with one or more kinds of surface ligands.

Without wishing to be bound by theory it is believed that such surface ligands may lead to disperse the semiconductor nanocrystal in a solvent more easily.

The surface ligands in common use include phosphines and phosphine oxides such as Trioctylphosphine oxide (TOPO), Trioctylphosphine (TOP), and Tributylphosphine (TBP); phosphonic acids such as Dodecylphosphonic acid (DDPA), Tridecylphosphonic acid (TDPA), Octadecylphosphonic acid (ODPA), and Hexylphosphonic acid (HPA); amines such as Dedecyl amine (DDA), Tetradecyl amine (TDA), Hexadecyl amine (HDA), and Octadecyl amine (ODA), thiols such as hexadecane thiol and hexane thiol; mercapto carboxylic acids such as mercapto propionic acid and mercaptoundecanoicacid; and a combination of any of these.

Examples of surface ligands have been described in, for example, the international patent application laid-open No. WO 2012/059931A.

Organic Material (130)

According to the present invention, an organic material can be selected from one or more members of the group consisting of alkyl chains having 5-42 carbon atoms, alkenyl chains having 5-42 carbon atoms, and alcohols having 5 to 42 carbon atoms.

In a preferred embodiment of the present invention, the organic material is selected from one or more members of the group consisting of alkyl chains having 5-42 carbon atoms, and alkenyl chains having 5-42 carbon atoms.

According to the present invention, the alkyl chain, or the alkenyl chain can be straight chain or branched chain, with preferably being of straight chain.

In some embodiments of the present invention, an alkyl chain having 1 to 25 carbon atoms or an alkenyl chain having 1 to 25 carbon atoms can be unsubstituted, mono- or polysubstituted by halogen or CN, it being also possible for one or more non-adjacent CH₂ groups to be replaced, in each occurrence independently from one another, by —O—, —S—, —NH—, —N(CH₃)—, —CO—, —COO—, —COO—, —O—CO—O—, —S—CO—, —CO—S—, —CH═CH—, —CH═CF—, —CF═CF— or —C≡C— in such a manner that oxygen atoms are not linked directly to one another.

In a preferred embodiment of the present invention, said alkyl chains having 5-42 carbon atoms, and alkenyl chains having 5-42 carbon atoms are unsubstituted.

Such as an organic material selected from one or more members of the group consisting of Nonan, Decan, Undecan, Dodecan, Tridecan, Tetradecan, Pentadecan, Hexadecan, Heptadecan, Octadecan, Nonadecan, Eicosan, Heneicosan, Docosan, Tricosan, Tetracosan, Pentacosan, Hexacosan, Heptacosan, Octacosan, Nonacosan, Triacontan, Hentriacontan, Dotriacontan, Tritriacontan, Tetratriacontan, Pentatriacontan, Hexatriacontan, Heptatriacontan, Octatriacontan, Nonatriacontan, Tetracontan, Hentetracontan, and Dotetracontan, 1-hexene, 1-heptene, 1-octene,1-decene, 1-undecene, 1-dodecene, 1-tridecene, 1-tetradecene, 1-pentadecene, 1-hexadecene, 1-heptadecene, 1-octadecene,1-nonadecene, 1-eicocene, 1-heneicosene, 1-dococene, 1-tricocene, 1-etracocene, 1-pentacocene, 1-hexacocene, 1-heptacocene, octacocene, 1-nonacocene, ethyl-decene, and methyl-hexene.

In a preferred embodiment of the present invention, the organic material (130) is selected from one or more of alkyl chains having 6 to 30 carbon atoms or alkenyl chains having 6 to 30 carbon atoms.

More preferably, the organic material (130) is selected from one or more of alkyl chains having 16-30 carbon atoms, and alkenyl chains having 16-30 carbon atoms.

Even more preferably, the organic material (130) is selected from one or more members of the group consisting of octadecane, tetracosane, octacosan, octadecene.

In some embodiments of the present invention, the ratio of the nanosized light emitting material (120) and the organic material (130) in the inner core (110) is in the range from 0.1:100 to 100:1.

In a preferred embodiment of the present invention, the ratio of the nanosized light emitting material (120) and the organic material (130) in the inner core (110) is in the range from 1:30 to 100:1 with being more preferably in the range from 1:10 to 99:1.

Polymer Layer (140)

According to the present invention, as a polymer layer (140), a wide variety of publically known transparent polymers can be used preferably. Especially, transparent polymers suitable for optical mediums such as optical devices can be used more preferably.

According to the present invention, the term “transparent” means at least around 60% of incident light transmit at the thickness used in an optical medium and at a wavelength or a range of wavelength used during operation of an optical medium. Preferably, it is over 70%, more preferably, over 75%, the most preferably, it is over 80%.

According to the present invention the term “polymer” means a material having a repeating unit and having the weight average molecular weight (Mw) 1000 or more.

In a preferred embodiment of the present invention, the weight average molecular weight (Mw) of the transparent polymer is in the range from 1,000 to 250,000.

More preferably it is from 5,000 to 200,000 with more preferably being from 10,000 to 150,000.

According to the present invention, the molecular weight M_{w} can be determined by means of GPC (=gel permeation chromatography) against an internal polystyrene standard.

In a preferred embodiment of the present invention the polymer layer (140) comprises a transparent polymer selected from one or more members of the group consisting of poly (meth)acrylates, polystyrene methyl (meth)acrylates, polystyrene, polyvinyl acetate, and polydivinylbenzene.

More preferably, the polymer layer (140) is a transparent polymer selected from one or more members of the group consisting of poly (meth)acrylates, polystyrene methyl (meth)acrylates, polystyrene, polyvinyl acetate, and polydivinylbenzene.

More preferably, the polymer layer (140) comprises a transparent polymer selected from one or more members of the group consisting of polydivinylbenzene, poly methyl (meth)acrylates, and polystyrene methyl (meth)acrylates.

Even more preferably, the polymer layer (140) is a transparent polymer selected from one or more members of the group consisting of polydivinylbenzene, poly methyl (meth)acrylates, and polystyrene methyl (meth)acrylates.

In some embodiments of the present invention, the polymer layer (140) further can comprise a nanosized light emitting material (120).

In some embodiments of the present invention, the polymer layer (140) comprises a plurality of nanosized light emitting materials (120).

By changing total amount of nanosized light emitting materials (120) used in step (a), and stirring speed/time in step (b), the amount of nanosized light emitting materials (120) in the polymer layer (140) can be controlled.

According to the present invention, in some embodiments, the polymer layer (140) can be at least partly covered with a ligand and/or a protection layer (150).

Preferably, the polymer layer (140) is covered with a ligand and/or a protection layer.

In some embodiments of the present invention, the protection layer (150) can further be covered with a ligand.

Ligand

In some embodiments of the present invention, the polymer layer (140) or a protection layer (150) can additionally comprise a surface ligand.

The surface of the polymer layer (140) or a protection layer (150) can be over coated with one or more kinds of surface ligands.

Without wishing to be bound by theory it is believed that such surface ligands may lead to disperse the light luminescent particle (100) in a solvent or a matrix material more easily.

The surface ligands in common use include phosphines and phosphine oxides such as Trioctylphosphine oxide (TOPO), Trioctylphosphine (TOP), and Tributylphosphine (TBP); phosphonic acids such as Dodecylphosphonic acid (DDPA), Tridecylphosphonic acid (TDPA), Octadecylphosphonic acid (ODPA), and Hexylphosphonic acid (HPA); amines such as Dedecyl amine (DDA), Tetradecyl amine (TDA), Hexadecyl amine (HDA), and Octadecyl amine (ODA), thiols such as hexadecane thiol and hexane thiol; mercapto carboxylic acids such as mercapto propionic acid and mercaptoundecanoicacid; and a combination of any of these.

Examples of surface ligands have been described in, for example, the international patent application laid-open No. WO 2012/059931A.

Protection Layer

According to present invention, any type of optically transparent material can be used as a protection layer (150).

In some embodiments, the protection layer (150) comprises a transparent polymer.

In some embodiments of the present invention, wherein the weight average molecular weight (Mw) of the transparent polymer of the protection layer can be in the range from 1,000 to 250,000.

Thus, in some embodiments of the present invention, the weight average molecular weight (Mw) of the transparent polymer of the polymer layer (140) or the protection layer (150) is in the range from 1,000 to 250,000.

In a preferred embodiment of the present invention, the transparent polymer is selected from one or more of members of the group consisting of polyvinyl alcohols, polyethyl imides, polydivinylbenzene, polymethyl (meth)acrylates, polystyrene methyl (meth)acrylates, polysiloxanes, and polysilazanes.

Thus, in a preferred embodiment of the present invention, the protection layer comprises a transparent polymer selected from one or more of members of the group consisting of polyvinyl alcohols, polyethyl imides, polydivinylbenzene, polymethyl (meth)acrylates, polystyrene methyl (meth)acrylates, polysiloxanes, and polysilazanes.

More preferably, the protection layer is a transparent polymer selected from one or more of members of the group consisting of polyvinyl alcohols, polyethyl imides, polydivinylbenzene, polymethyl (meth)acrylates, polystyrene methyl (meth)acrylates, polysiloxanes, and polysilazanes.

More preferably, the protection layer (150) comprises a transparent polymer selected from one or more members of the group consisting of polyvinyl alcohols, polyethyl imides, polydivinylbenzene, polymethyl (meth)acrylates, polystyrene methyl (meth)acrylates, polysiloxanes, and polysilazanes.

Even more preferably, the protection layer (150) is a transparent polymer selected from one or more members of the group consisting of polyvinyl alcohols, polyethyl imides, polydivinylbenzene, polymethyl (meth)acrylates, polystyrene methyl (meth)acrylates, polysiloxanes, and polysilazanes.

Use of the Light Emitting Particle (100)

In another aspect, the present invention also relates to use of the light luminescent particle (100) in an optical medium or in a biomonitoring device.

Composition

In another aspect, the present invention further relates to a composition comprising the light luminescent particle (100), and one selected from a matrix material or a solvent.

Solvent

In some embodiments of the present invention, the composition comprises a solvent, if necessary.

Type of solvent is not particularly limited.

In some embodiments of the present invention, the solvent can be selected from the group consisting of purified water; ethylene glycol monoalkyl ethers, such as, ethylene glycol monomethyl ether, ethylene glycol monoethyl ether, ethylene glycol monopropyl ether, and ethylene glycol monobutyl ether; diethylene glycol dialkyl ethers, such as, diethylene glycol dimethyl ether, diethylene glycol diethyl ether, diethylene glycol dipropyl ether, propylene glycol methyl ether and diethylene glycol dibutyl ether; ethylene glycol alkyl ether acetates, such as, methyl cellosolve acetate and ethyl cellosolve acetate; propylene glycol alkyl ether acetates, such as, propylene glycol monomethyl ether acetate (PGMEA), propylene glycol monoethyl ether acetate, and propylene glycol monopropyl ether acetate; ketones, such as, methyl ethyl ketone, acetone, methyl amyl ketone, methyl isobutyl ketone, and cyclohexanone; alcohols, such as, ethanol, propanol, butanol, hexanol, cyclo hexanol, ethylene glycol, and glycerin; esters, such as, ethyl 3-ethoxypropionate, methyl 3-methoxypropionate and ethyl lactate; and cyclic asters, such as, γ-butyrolactone; chlorinated hydrocarbons, such as chloroform, dichloromethane, chlorobenzene, dichlorobenzene.

Those solvents are used singly or in combination of two or more, and the amount thereof depends on the coating method and the thickness of the coating.

More preferably, propylene glycol alkyl ether acetates, such as, propylene glycol monomethyl ether acetate (hereafter “PGMEA”), propylene glycol monoethyl ether acetate, propylene glycol monopropyl ether acetate, purified water or alcohols can be used.

The amount of the solvent in the composition can be freely controlled according to the method of coating the composition. For example, if the composition is to be spray-coated, it can contain the solvent in an amount of 90 wt. % or more. Further, if a slit-coating method, which is often adopted in coating a large substrate, is to be carried out, the content of the solvent is normally 60 wt. % or more, preferably 70 wt. % or more.

Matrix Materials,

According to the present invention, as the matrix material, any type of transparent polymers can be used preferably.

For examples, methyl-acrylate, methyl-methacrylate, ethyl-acrylate, ethyl-methacrylate, butyl-acrylate, butyl-methacrylate, 2-ethylhexyl-acrylate, 2-ethylhexyl-methacrylate; substituted alkyl-(meth)acrylates, for examples, hydroxyl-group, epoxy group, or halogen substituted alkyl-(meth)acrylates;

cyclopentenyl(meth)acrylate, tetra-hydro furfuryl-(meth)acrylate, benzyl (meth)acrylate, polyethylene-glycol di-(meth)acrylates, polysiloxanes, polysilazanes, postyrenes, polyvinyl acetate, polydivinylbenzene, or a combination of any of these, can be used preferably.

In view of better coating performance of the composition, sheet strength, and good handling, the matrix material has a weight average molecular weight in the range from 5,000 to 50,000 preferably, more preferably from 10,000 to 30,000.

According to the present invention, the molecular weight M_{w} can be determined by means of GPC (=gel permeation chromatography) against an internal polystyrene standard.

Optical Medium

In another aspect, the present invention further relates to an optical medium comprising the light luminescent particle (100).

In some embodiments of the present invention, the optical medium can be an optical film, for example, a color filter, color conversion film, remote phosphor tape, or another film or filter.

Optical Device

In another aspect, the invention further relates to an optical device comprising the optical medium.

In some embodiments of the present invention, the optical device can be a liquid crystal display, Organic Light Emitting Diode (OLED), backlight unit for display, Light Emitting Diode (LED), Micro Electro Mechanical Systems (here in after “MEMS”), electro wetting display, or an electrophoretic display, a lighting device, and/or a solar cell.

Fabrication Process

In another aspect, the present invention furthermore relates to method for preparing of the light luminescent particle (100), wherein the method comprises following step (a), (b) and (c),

(a) preparing a composition comprising a nanosized light emitting material (110), and an organic material (130), a precursor for the polymer layer (140), a polymerization initiator, a polar solvent, and a polymer solved in said polar solvent,
(b) stirring the composition obtained in step (a) at a temperature in the range from the melting point of the organic material (130) to 99° C.,
(c) polymerizing the precursor by heat treatment, by irradiating a ray of light, or a combination of any of these.

Preferably, step (a) is also carried out at a temperature in the range from the melting point of the organic material (130) to 99° C. to obtain better emulsified composition in step (b).

Or step (a) can be carried out at a temperature in the range from 20° C. to 50° C. to avoid unnecessal polymerization by heat in step (a).

In a preferred embodiment of the present invention, all steps are carried out under inert condition such as under N₂ condition.

In some embodiments of the present invention, step (b) and step (c) can be carried out at the same time or in this sequence.

Preferably, untrasonification such as ultrasonic probe (from Hielscher UP200Ht) is used in step (b) to control average particle size and ensure smaller particle size and a better size distribution of particles at the same time.

Microcapsulation methods can be used for this invention have been described in, for example, A. Chaiyasat et. al., eXPRESS polymer Letters Vol. 6, No. 1, (2012) 70-77.

Polymerization Initiator

According to the present invention, the composition contains a polymerization initiator. Generally, there are two kinds of polymerization initiators which can be used in the present invention: one is a polymerization initiator generating an acid, base, or radical when exposed to radiation, and the other is a polymerization initiator generating an acid, base or radical when exposed to heat.

The polymerization initiator adoptable in the present invention is, for example, a photo acid-generator, which decomposes when exposed to radiation and releases an acid serving as an active substance for photo-curing the composition; a photo radical-generator, which releases a radical; a photo base-generator, which releases a base; a heat acid-generator, which decomposes when exposed to heat and releases an acid serving as an active substance for heat-curing the composition; a heat radical-generator, which releases a radical; and a heat base-generator, which releases a base. Examples of the radiation include visible light, UV rays, IR rays, X-rays, electron beams, α-rays and γ-rays.

In a preferred embodiment of the present invention, the amount of the polymerization initiator is in the range from 0.001 to 10 weight parts, more preferably 0.01 to 5 weight parts, based on 100 weight parts of the a precursor for the polymer layer.

Among the photo acid-generators usable in the present invention, those generating sulfonic acids or boric acids are particularly preferred. Examples thereof include tricumyliodonium teterakis(pentafluoro-phenyl)-borate (PHOTOINITIATOR2074 [trademark], manufactured by Rhodorsil), diphenyliodonium tetra(perfluorophenyl)borate, and a compound having sulfonium ion and pentafluoroborate ion as the cation and anion moieties, respectively. Further, examples of the photo acid-generators also include triphenylsulfonium trifluoromethanesulfonate, triphenylsulfonium camphor-sulfonate, triphenylsulfonium tetra(perfluorophenyl)borate, 4-acetoxyphenyldimethylsulfonium hexafluoroarsenate, 1-(4-n-butoxynaphthalene-1-yl)tetra-hydro-thiophenium trifluoromethanesulfonate, 1-(4,7-dibutoxy-1-naphthalenyl)tetrahydro-thiophenium trifluoromethanesulfonate, diphenyliodonium trifluoro-methanesulfonate, and diphenyliodonium hexafluoroarsenate. Furthermore, it is still also possible to adopt photo acid-generators represented by the following formulas:

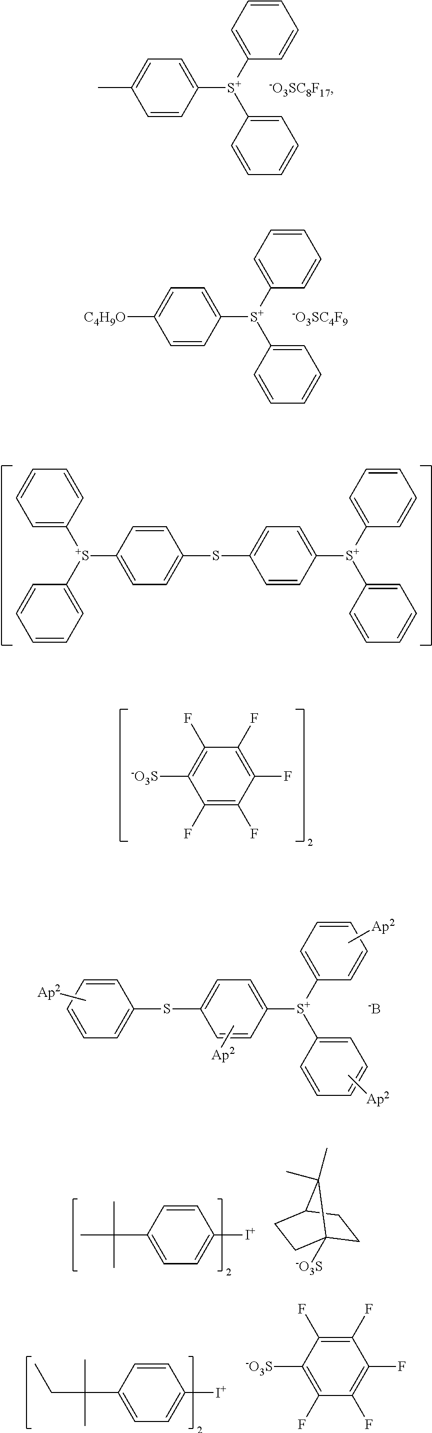

in which
each A is independently a substituent group selected from the group consisting of an alkyl group of 1 to 20 carbon atoms, an alkoxy group of 1 to 20 carbon atoms, an aryl group of 6 to 20 carbon atoms, an alkylcarbonyl group of 1 to 20 carbon atoms, an arylcarbonyl group of 6 to 20 carbon atoms, hydroxyl group, and amino group;
each p² is independently an integer of 0 to 5; and B⁻ is a fluorinated alkylsulfonate group, a fluorinated arylsulfonate group, a fluorinated alkylborate group, an alkylsulfonate group or an arylsulfonate group.

It is also possible to use photo acid-generators in which the cations and anions in the above formulas are exchanged each other or combined with various other cations and anions described above. For example, any one of the sulfonium ions represented by the above formulas can be combined with tetra(perfluorophenyl)borate ion, and also any one of the iodonium ions represented by the above formulas can be combined with tetra(perfluoro-phenyl)borate ion. Those can be still also employed as the photo acid-generators.

The heat acid-generator is, for example, a salt or ester capable of generating an organic acid. Examples thereof include: various aliphatic sulfonic acids and salts thereof; various aliphatic carboxylic acids, such as, citric acid, acetic acid and maleic acid, and salts thereof; various aromatic carboxylic acids, such as, benzoic acid and phthalic acid, and salts thereof; aromatic sulfonic acids and ammonium salts thereof; various amine salts; aromatic diazonium salts; and phosphonic acid and salts thereof. Among the heat acid-generators usable in the present invention, salts of organic acids and organic bases are preferred, and further preferred are salts of sulfonic acids and organic bases.

Examples of the preferred heat acid-generators containing sulfonate ions include p-toluenesulfonates, benzenesulfonates, p-dodecylbenzenesulfonates, 1,4-naphthalenedisulfonates, and methanesulf.

Examples of the photo radical-generator include azo compounds, peroxides, acyl phosphine oxides, alkyl phenons, oxime esters, and titanocenes.

According to the present invention, as the photo radical-generator, acyl phosphine oxides, alkyl phenons, oxime esters, or a combination of any of these are more preferable. For examples, 2,2-dimethxye-1,2-diphenylethane-1-on, 1-hydroxy-cyclohexylphenylketone, 2-hydroxy-2-methyl-1-phenylpropan-1-on, 1-[4-(2-hydroxyethoxy)phenyl]-2-hydroxy-2-methyl-1-propane-1-on, 2-hydroxy-1-{4-[4-(2-hydroxy-2-methylpropionyl)benzyl]phenyl}-2-methylpropane-1-on, 2-methyl-1-(4-methylthiophenyl)-2-morpholinopropane-1-on, 2-benzyl-2-dimethylamino-1-(4-morpholinophenyl)-1-butanone, 2-(dimethylamino)-2-[(4-methylphenon)methyl]-1-[4-(4-morpholinyl)phenyl]-1-butanone, 2,4,6-trimethylbenzoyl-diphenylphosphine oxide, bis(2,4,6-trimethylbenzoyl)phenylphosphine oxide, 1,2-octanedione 1-[4-(phenylthio)-2-(o-benzoyl oxime)], ethanone 1-[9-ethyl-6-(2-methylbenzoyl)-9H-carbazole-3-yl]-1-(o-acetyl oxime) or a combination of any of these can be used preferably.

As the examples of the heat radical-generator, 2,2′ azobis(2-methylvaleronitrile), 2,2′-azobis(dimethylvaleronitrile) or a combination of any of these can be used preferably.

Examples of the photo base-generator include multi-substituted amide compounds having amide groups, lactams, imide compounds, and compounds having those structures.

Examples of the above heat base-generator include: imidazole derivatives, such as, N-(2-nitrobenzyloxycarbonyl)imidazole, N-(3-nitrobenzyloxy-carbonyl)imidazole, N-(4-nitrobenzyloxycarbonyl)imidazole, N-(5-methyl-2-nitrobenzyloxycarbonyl)imidazole, and N-(4-chloro-2-nitro-benzyloxycarbonyl)imidazole; 1,8-diazabicyclo(5,4,0)undecene-7, tertiary amines, quaternary ammonium salts, and mixture thereof. Those base-generators as well as the acid-generators and/or radical-generators can be used singly or in mixture.

Polar Solvent

According to the present invention, for method for preparing of the light luminescent particle (100), any type of polar solvent can be used singly or in mixture.

In some embodiments of the present invention, the polar solvent can be selected from the group consisting of purified/deionized water; ethylene glycol monoalkyl ethers, such as, ethylene glycol monomethyl ether, ethylene glycol monoethyl ether, ethylene glycol monopropyl ether, and ethylene glycol monobutyl ether; diethylene glycol dialkyl ethers, such as, diethylene glycol dimethyl ether, diethylene glycol diethyl ether, diethylene glycol dipropyl ether, and diethylene glycol dibutyl ether; ethylene glycol alkyl ether acetates, such as, methyl cellosolve acetate and ethyl cellosolve acetate; propylene glycol alkyl ether acetates, such as, propylene glycol monomethyl ether acetate (PGMEA), propylene glycol monoethyl ether acetate, and propylene glycol monopropyl ether acetate; ketones, such as, methyl ethyl ketone, acetone, methyl amyl ketone, methyl isobutyl ketone, and cyclohexanone; alcohols, such as, ethanol, propanol, butanol, hexanol, cyclo hexanol, ethylene glycol, and glycerin; esters, such as, ethyl 3-ethoxypropionate, methyl 3-methoxypropionate and ethyl lactate; and cyclic asters, such as, γ-butyrolactone; chlorinated hydrocarbons, such as chloroform, dichloromethane, chlorobenzene, dichlorobenzene.

Those solvents can be used singly or in combination of two or more.

More preferably, propylene glycol alkyl ether acetates, such as, propylene glycol monomethyl ether acetate (hereafter “PGMEA”), propylene glycol monoethyl ether acetate, propylene glycol monopropyl ether acetate, purified/deionized water or alcohols can be used.

Even more preferably, purified deionized water can be used.

Other Additives

The composition of the present invention may contain other additives, if necessary. Such as polymerization inhibitor, and sensitizer.

### Effect of the Invention

The present invention provides,
1. Novel light luminescent particle comprising a nanosized light emitting material, which shows better initial absolute quantum yield after fabrication of said light luminescent particle,
2. Novel light luminescent particle comprising a nanosized light emitting material, having improved thermal resistivity,
3. Novel light luminescent particle comprising a nanosized light emitting material, which provide better moisture resistivity,
4. Novel light luminescent particle comprising a nanosized light emitting material, having longer life time,
5. Simple fabrication process for making a light luminescent particle comprising a nanosized light emitting material.

### Definition of Terms

The term “semiconductor” means a material which has electrical conductivity to a degree between that of a conductor (such as copper) and that of an insulator (such as glass) at room temperature. Preferably, a semiconductor is a material whose electrical conductivity increases with the temperature.

The term “inorganic” means any material not containing carbon atoms or any compound that containing carbon atoms ionically bound to other atoms such as carbon monoxide, carbon dioxide, carbonates, cyanides, cyanates, carbides, and thiocyanates.

The term “emission” means the emission of electromagnetic waves by electron transitions in atoms and molecules.

The working examples 1-8 below provide descriptions of the present invention, as well as an in detail description of their fabrication.

### WORKING EXAMPLES

### Working Example 1: Preparation of Light Luminescent Particles

0.27 g of polyvinyl alcohol (Mowiol® 8-88, Mw: 67,000 from Sigma Aldrich, hereafter “PVA”) is dissolved in 30.0 ml of deionized water. Then, 1.5 g of divinyl benzene (hereafter “DVB”) is mixed with 45 mg of quantum sized materials (from Merck, hereafter “QM”) in octadecane (hereafter “OD”) solution (3 wt % of quantum sized material in octadecane) and 0.16 g of Benzoylperoxide.

Then the obtained DVB/OD/BPO/QM solution is mixed with the PVA/water solution and emulsified with T18 digital ULTRA-TURRAX® at 5000 rpm for 5 min. Then the droplet size of the emulsion is decreased further with an ultrasonic probe (from Hielscher UP200Ht) for 5 min with 30W.

All steps above are done at 40° C. to prevent octadecane from solidifying. Then emulsion is transferred to a glass flask and polymerized at 70° C. for 24 hours under argon atmosphere.

Finally, sample is taken. (Sample 1)

### Working Example 2: Preparation of Light Luminescent Particles

0.27 g of polyvinyl alcohol (Mowiol® 8-88, Mw: 67,000 from Sigma Aldrich, hereafter “PVA”) is dissolved in 30.0 ml of deionized water. Then, 1.5 g of divinyl benzene (hereafter ““DVB””) is mixed with 45 mg of quantum sized materials (from Merck, hereafter “QM”) in tetracosane solution (3 wt % of quantum sized material in tetracosane) and 0.16 g of Benzoylperoxide. Then the obtained DVB/tetracosane//BPO/QM solution is mixed with the PVA/water solution and emulsified with T18 digital ULTRA-TURRAX® at 5000 rpm for 5 min. Then the droplet size of the emulsion is decreased further with an ultrasonic probe (from Hielscher UP200Ht) for 5 min with 30W.

All steps above are done at 55° C. to prevent tetracosane from solidifying. Then emulsion is transferred to a glass flask and polymerized at 70° C. for 24 hours under argon atmosphere.

Finally, sample is taken. (Sample 2)

### Working Example 3: Preparation of Light Luminescent Particles

Light luminescent particles are prepared in the same manner as described in the working example 1 except for Octacosan is used instead of octadecane.

All steps above are done at 65° C. to prevent octacosan from solidifying. Then emulsion is transferred to a glass flask and polymerized at 70° C. for 24 hours under argon atmosphere.

Finally, sample is taken. (Sample 3)

### Working Example 4: Preparation of Light Luminescent Particles

Light luminescent particles are prepared in the same manner as described in the working example 1 except for 1-Octadecene was used instead of octadecane.

Finally, sample is taken. (Sample 4)

### Working Example 5: QY Evaluation

The samples 1-4 obtained in working examples 1-4 are stored in ambient atmosphere at room temperature.

The PL quantum yield (hereafter “QY”) of samples 1 to 4 are each independently measured by Quantaurus-QY Absolute PL quantum yields measurement system C11347-11 (Hamamatsu).

Table 1 shows the results of the measurement.

TABLE 1

| | | Melting | | | | |
|---|---|---|---|---|---|---|
| | | Point | QY | Abs | CWL | FWHM |
| Sample | Core | [° C.] | [%] | [%] | [nm] | [nm] |
| 1 | Octadecane | 29 | 68.6 | 38.2 | 636 | 31 |
| 2 | Octacosane | 61 | 73.0 | 52.6 | 637 | 31 |
| 3 | Tetracosane | 51 | 73.2 | 37.3 | 637 | 31 |
| 4 | 1-Octadecene | 18 | 75.2 | 39.3 | 634 | 29 |

### Comparative Example 1: Preparation of Light Luminescent Particles

Quantum sized materials covered by poly divinyl benzene without organic material (without octadecane) fabricated with micro capsulation method is prepared.

### Comparative Example 2: QY Evaluation

The sample obtained in comparative example 1 (here after sample 5) is stored in ambient atmosphere at room temperature.

The PL quantum yield (hereafter “QY”) of sample is measured by Quantaurus-QY Absolute PL quantum yields measurement system C11347-11 (Hamamatsu).

Table 2 shows the results of the measurement.

TABLE 2

| | | QY | Abs | CWL | FWHM |
|---|---|---|---|---|---|
| Sample | Core | [%] | [%] | [nm] | [nm] |
| 5 | — | 47.1 | 17.0 | 632 | 31 |

### Working Example 6: Preparation of an Optical Medium Comprising a Light Luminescent Particle

The light luminescent particles obtained in working example 1 are dispersed in a PVA-purified water mixture (PVA: purified water=1:20). Then the mixture is dispensed on a glass substrate. It is then cured on a hotplate at 80° C. for 30 min. Finally, optical film 1 is obtained.

### Comparative Example 3: Preparation of an Optical Medium Comprising a Light Luminescent Particle

The optical film 2 is fabricated in the same manner as described in working example 6, except for the light luminescent particles obtained in comparative example 1 are used instead of the light luminescent particles obtained in working example 1.

### Working Example 7: Thermal—Humidity Stability Measurement

The optical films from working example 6 and comparative example 3 are placed in an oven at 85° C./85% of relative humidity (hereafter RH) in air.

The absolute Quantum Yield (QY) values are measured directly by using an absolute photoluminescence QY spectrometer (Hamamatsu model: Quantaurus C11347).

FIG. 2 shows the Normalized Quantum yield as function of time for nanosized light emitting material of the films from working example 6, and comparative working example 3.

### Working Example 8: Preparation of Light Luminescent Particles

Light luminescent particles are prepared in the same manner as described in the working example 1 except for 15.3 wt. % of quantum sized material in octadecane is used instead of 3 wt % of quantum sized material in octadecane.

Finally, sample 6 is taken.

And the absolute PL quantum yield of sample 6 is measured in the same manner as described in working example 5. The absolute PL quantum yield of sample 6 is 81%.

1. A light luminescent particle (100) comprising an inner core (110) and a polymer layer (140) placed over the inner core (110), wherein said inner core (110) comprises a nanosized light emitting material (120), and an organic material (130) selected from one or more members of the group consisting of alkyl chains having 5-42 carbon atoms, alkenyl chains having 5-42 carbon atoms, and alcohols having 5 to 42 carbon atoms.

2. The light luminescent particle (100) according to claim 1, wherein said inner core (110), comprises a nanosized light emitting material (120), and an organic material (130) selected from one or more members of the group consisting of alkyl chains having 5-42 carbon atoms, and alkenyl chains having 5-42 carbon atoms.

3. The light luminescent particle (100) according to claim 1, wherein the organic material (130) is selected from one or more of alkyl chains having 6 to 30 carbon atoms or alkenyl chains having 6 to 30 carbon atoms.

4. The light luminescent particle (100) according to claim 1, wherein the organic material (130) is selected from one or more of alkyl chains having 16-30 carbon atoms, and alkenyl chains having 16-30 carbon atoms.

5. The light luminescent particle (100) according to claim 1, wherein the ratio of the nanosized light emitting material (120) and the organic material (130) is in the range from 0.1:100 to 100:1.

6. The light luminescent particle (100) according to claim 1, wherein the polymer layer (140) comprises a transparent polymer selected from one or more members of the group consisting of poly (meth)acrylates, polystyrene methyl (meth)acrylates, polystyrene, polyvinyl acetate, and polydivinylbenzene.

7. The light luminescent particle (100) according to claim 1, wherein the polymer layer (140) comprises a transparent polymer selected from one or more members of the group consisting of polydivinylbenzene, poly methyl (meth)acrylates, and polystyrene methyl (meth)acrylates.

8. The light luminescent particle (100) according to claim 1, wherein the polymer layer (140) is at least partly covered with a ligand and/or a protection layer (150).

9. The light luminescent particle (100) according to claim 1, wherein said protection layer (150) comprises a transparent polymer.

10. The light luminescent particle (100) according to claim 1, wherein the protection layer (150) comprises a transparent polymer selected from one or more of members of the group consisting of polyvinyl alcohols, polyethyl imides, polydivinylbenzene, polymethyl (meth)acrylates, polystyrene methyl (meth)acrylates, polysiloxanes, and polysilazanes.

11. The light luminescent particle (100) according to claim 1, wherein the weight average molecular weight (Mw) of the transparent polymer of the polymer layer (140) or of the protection layer (150) is in the range from 1,000 to 250,000.

12. (canceled)

13. A composition comprising the light luminescent particle (100) according to claim 1, and one selected from a matrix material or a solvent.

14. An optical medium comprising the light luminescent particle (100) according to claim 1.

15. An optical device comprising the optical medium according to claim 13.

16. Method for preparing of the light luminescent particle (100) according to claim 1, wherein the method comprises following step (a), (b) and (c),
(a) preparing a composition comprising a nanosized light emitting material (110), and an organic material (130), a precursor for the polymer layer (140), a polymerization initiator, a polar solvent, and a polymer solved in said polar solvent,
(b) stirring the composition obtained in step (a) at a temperature in the range from the melting point of the organic material (130) to 99° C.,
(c) polymerizing the precursor by heat treatment, by irradiating a ray of light, or a combination of any of these.
